(19) United States
(12) Patent Application Publication
(10) Pub. No.: US 2007/0043466 A1
(43) Pub. Date: Feb. 22, 2007

(54) Stereoscopic display using polarized eyewear

(76) Inventors: Michael A. Vesely, Santa Cruz, CA (US); Nancy L. Clemens, Santa Cruz, CA (US)

Correspondence Address: Tue Nguyen, 496 Olive Ave., Fremont, CA, 94539, US

(21) Appl. No.: 11/500,537

(22) Filed: Aug. 7, 2006

Related U.S. Application Data
(60) Provisional application No. 60/709,269, filed on Aug. 18, 2005.

(51) Int. Cl. G06F 19/00

(52) U.S. Cl. 700/166; 348/58; 700/117

(57) ABSTRACT

The present invention discloses a stereoscopic display employing polarized eyewear. The basic component of the present invention stereoscopic display is a stereopolarizer, which is a polarized screen comprising microscopic sections of mutually extinguishing polarizing filters dispersed throughout the screen. To achieve the proper resolution, the size of the microscopic polarizing filter needs to be in order of micrometer, from a few microns to a few hundred of microns. The arrangement of the microscopic polarizing filters can be alternating stripes in horizontal, vertical, or any arbitrarily direction. The microscopic polarizing filters can be arranged in alternating pattern, such as alternating square or circle. The polarizer screen can be one sheet or can be a composite sheet, comprising two distinct polarizer filter sheet laminated together. Laser drilling is used to fabricate the microscopic polarizing filters, primarily due to ease of operation and appropriate microscopic sizes. Further, laser drilling and cutting can form angle holes in the stereopolarizer, which provides optimum focus viewing for horizontal perspective display.

This application claims priority from U.S. provisional applications Ser. No. 60/709,269, filed Aug. 18, 2005, entitled “Stereoscopic display using polarized eyewear”, which is incorporated herein by reference.

### FIELD OF INVENTION

This invention relates to a three-dimensional simulator system, and in particular, to a stereoscopic three-dimensional display using polarized eyewear.

### BACKGROUND OF THE INVENTION

Ever since humans began to communicate through pictures, they faced a dilemma of how to accurately represent the three-dimensional (3D) world they lived in. The human eyes are two dimensional (2D) devices, and thus the brain is responsible for the three dimensional rendering. The disparity of the retinal images due to the separation of the two eyes is used to create the perception of depth. The effect is called stereoscopy where each eye receives a slightly different view of a scene, and the brain fuses them together using these differences to determine the ratio of distances between nearby objects.

Typical stereoscopic displays include methods with glasses such as anaglyph method, special polarized glasses or shutter glasses, methods without using glasses such as a parallax stereogram, a lenticular method, and mirror method (concave and convex lens).

In anaglyph method, a display image for the right eye and a display image for the left eye are respectively superimpose-displayed in two colors, e.g., red and blue, and observation images for the right and left eyes are separated using color filters, thus allowing a viewer to recognize a stereoscopic image. From the early days of the anaglyph method, there are many improvements such as the spectrum of the red/blue glasses and display to generate much more realism and comfort to the viewers.

In polarized glasses method, the left eye image and the right eye image are separated by the use of mutually extinguishing polarizing filters such as orthogonal linear polarizer, circular polarizer, elliptical polarizer. The images are normally projected onto screens with polarizing filters and the viewer is then provided with corresponding polarized glasses. The left and right eye images appear on the screen at the same time, but only the left eye polarized light is transmitted through the left eye lens of the eyeglasses and only the right eye polarized light is transmitted through the right eye lens.

Another way for stereoscopic display is the image sequential system. In such a system, the images are displayed sequentially between left eye and right eye images rather than superimposing them upon one another, and the viewer's lenses are synchronized with the screen display to allow the left eye to see only when the left image is displayed, and the right eye to see only when the right image is displayed. The shuttering of the glasses can be achieved by mechanical shuttering or with liquid crystal electronic shuttering. In shuttering glass method, display images for the right and left eyes are alternately displayed on a CRT in a time sharing manner, and observation images for the right and left eyes are separated using time sharing shutter glasses which are opened/closed in a time sharing manner in synchronism with the display images, thus allowing an observer to recognize a stereoscopic image.

Other way to display stereoscopic images is by optical method. In this method, display images for the right and left eyes, which are separately displayed on a viewer using optical means such as prisms, mirror, lens, and the like, are superimpose-displayed as observation images in front of an observer, thus allowing the observer to recognize a stereoscopic image. Large convex or concave lenses can also be used where two image projectors, projecting left eye and right eye images, are providing focus to the viewer's left and right eye respectively. A variation of the optical method is the lenticular method where the images form on cylindrical lens elements or two dimensional arrays of lens elements.

### SUMMARY OF THE INVENTION

The present invention discloses a stereoscopic display employing polarized eyewear. The basic component of the present invention stereoscopic display is a stereopolarizer, which is a polarized screen comprising microscopic sections of mutually extinguishing polarizing filters dispersed throughout the screen. The stereoscopic display according to the present invention comprises the showing of spatially multiplexed images, for example a left image and a right image. The stereopolarizer is positioned synchronizedly with the left and right images so that all the pixels forming the left image are matched with one type of polarizing filter and the pixels forming the right image are matched with the other type of polarizing filter. Thus a user equipped with a polarized eyewear corresponding to the stereopolarizer screen can see the left image with the left eye and the right image with the right eye.

To achieve the proper resolution, the size of the microscopic polarizing filter needs to be in order of micrometer, from a few microns to a few hundred of microns. The arrangement of the microscopic polarizing filters can be alternating stripes in horizontal, vertical, or any arbitrarily direction. The microscopic polarizing filters can be arranged in alternating pattern, such as alternating square or circle. The polarizer screen can be one sheet or can be a composite sheet, comprising two distinct polarizer filter sheet laminated together.

The present invention further discloses a method to fabricate the microscopic polarizing filters by the use of laser drilling. Laser drilling is well suitable for cutting out the microscopic size of the polarizing filters and two filters can be laminated together to form the composite stereopolarizer. Laser drilling or cutting offers the proper dimension for optimum display, in the micron range (1 μm-1000 μm). Laser drilling or cutting can cut through or stop at any screen thickness.

Further, laser drilling and cutting can form angle holes in the stereopolarizer, which provides optimum focus viewing for horizontal perspective display. Horizontal perspective preferably services a single user, and thus the polarizer can have the drilled angle focus toward the user point of view, minimizing distortion and discomfort.

### BRIEF DESCRIPTION OF THE DRAWINGS

FIG. 1 shows a stereoscopic display using polarizing eyewear.

FIGS. 2A and 2B show different embodiments of the stereopolarizer.

FIG. 3 shows a composite polarizer.

FIGS. 4A-4E show various embodiments of composite polarizer.

FIGS. 5A-5E show various embodiments of polarizer patterns.

FIG. 6 shows the comparison of central perspective (Image A) and horizontal perspective (Image B).

FIG. 7 shows the method of drawing a horizontal perspective drawing.

FIG. 8 shows the angled drilled holes for the polarizer for horizontal perspective method.

### DETAILED DESCRIPTION OF THE INVENTION

The present invention discloses a stereoscopic display system employing polarizing eyewear. The fundamental principle of stereoscopic display is that the two eyes sees slightly different images, and these two images are fused together to form the 3D illusion.

Polarizing eyewear employs polarizing filters to achieve the effect. The eyewear comprises mutually extinguished polarizing filters, such as orthogonal linear polarizer, circular polarizer, elliptical polarizer, for the two eyes. Correspondingly, the images are displayed through similar polarizer filters so that the eyes see proper images.

There are various ways to display polarized images such as spatially multiplexed, spatially supposition, or time sequentially. In spatially multiplexed method, the display comprises both the left and the right images, displayed through a dispersion pattern such as a checkerboard or alternate line. For example, in the alternate line pattern, all the odd lines display the left image and all the even lines display the right image. In spatially supposition method, the left and the right image are displayed together and on top of each other. In time sequentially method, the left and right images are displayed sequentially.

Among these methods, the present invention is related to the spatially multiplexed display, meaning the display comprises both the left and right images dispersed through a dispersion pattern in the display. The spatially multiplexed display is well suited to LCD (liquid crystal display) displays, since LCD displays comprise individual pixels that can be addressed individually. Thus a LCD display can be configured to display spatially multiplexed images. Other display can also be configured to display spatially multiplexed images, for example, CRT (cathode ray tube) displays normally use interlaced images, and thus can display the left image and then interlacing with the right image. The dispersion pattern in this case is a horizontal line pattern.

The spatially multiplexed display typically comprises two components, a spatially multiplexed display to display both left and right images, and a stereopolarizer to ensure that the displayed images have proper polarization. The stereopolarizer is also a spatially multiplexed polarizer, matching the spatially multiplexed display.

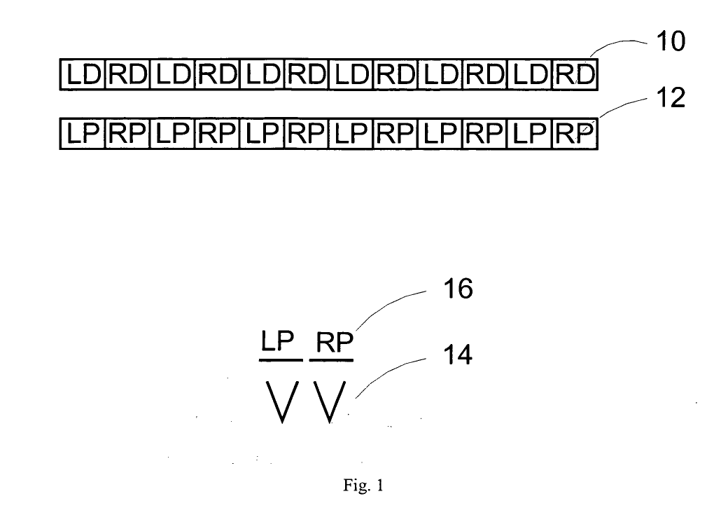

FIG. 1 shows a cross-section of the present invention stereoscopic display using polarizing eyewear. The display system comprises a spatially multiplexed display 10, which displays left LD and right RD pixels, dispersing throughout the display. The left LD and right RD pixels are typically alternate to achieve the best display resolution. The combinations of all the left LD and right RD pixels form the left and right images, respectively. The display system also comprises a stereopolarizer 12, which is also, a spatially multiplexed polarizer, comprising left LP and right RP polarizing filters. The left LP and right RP polarizing filters are correspondingly matched with the spatially multiplexed display left LD and right RD pixels of the display 10. A viewer 14 uses a polarizing eyewear 16 comprising left LP and right RP polarizing filters to ensure that the left and right eyes see the left and right images, respectively.

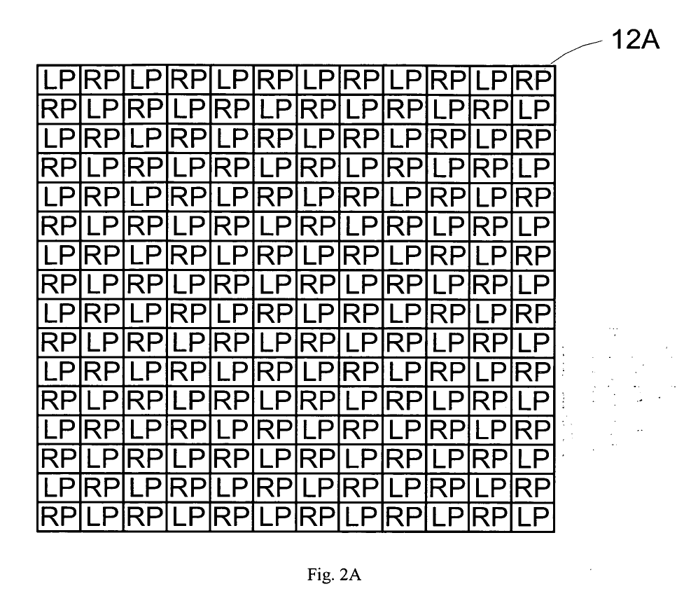

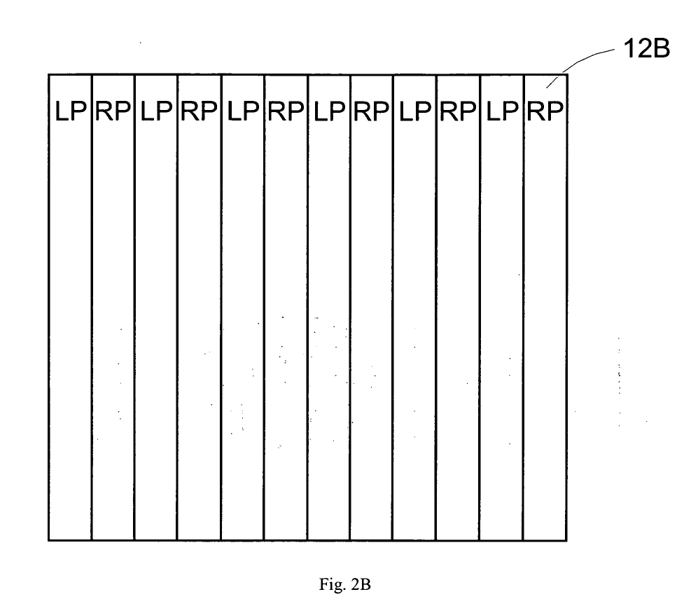

FIG. 2A shows a stereopolarizer 12A having a checkerboard dispersion pattern. The microscopic section left LP and right RP polarizer filters form a checkerboard pattern throughout the polarizer. In this figure, the LP and RP filters are shown to be square shape, but other shapes are possible, such as circle, rectangular, or oval. The smaller the filters are, the better the display resolution, and thus the size of the filter is in the range of microns (1 μm to 1000 μm). Submicron filters are also possible, but that high resolution achievement depends on the high resolution display and the polarizer fabrication process.

FIG. 2B shows a stereopolarizer 12B having a line dispersion pattern. The microscopic section left LP and right RP polarizer filters form alternate line pattern throughout the polarizer. In this figure, the LP and RP filters are shown to be vertical lines, but other directions are possible, such as horizontal, or at an angle.

The present invention also discloses a fabrication method to form the stereopolarizer by laser drilling or cutting. Laser drilling is well suitable for cutting out the microscopic size of the polarizing filters and two filters can be laminated together to form the composite stereopolarizer. Laser drilling or cutting offers the proper dimension for optimum display, in the micron range (1 μm-1000 μm). Laser drilling or cutting can cut through or stop at any screen thickness. Further, laser drilling and cutting can form angle holes in the stereopolarizer.

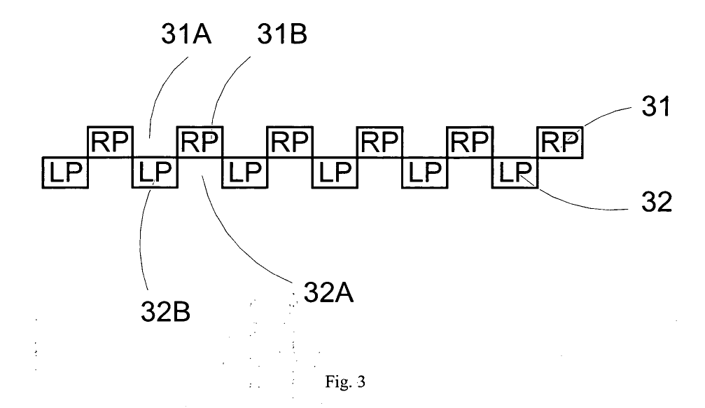

The polarizer can be by itself, or it can be laminated to a non-polarized transparent sheet. Two polarizers with proper laser drilled holes can be laminated together to form a stereopolarizer. FIG. 3 shows a stereopolarizer comprising two polarizers 31 and 32. Polarizer 31 has sections 31A drilled out by laser, leaving only the polarizing section 31B. Also polarizer 32 has sections 32A drilled out by laser, leaving only the polarizing section 32B. The two polarizers 31 and 32 are laminated together with the polarizing sections of one polarizer corresponded to the drilled out sections of other polarizer. The drilled out sections and the polarizing sections can have various sizes, and the drilled out sections can be larger or smaller than the polarizing sections.

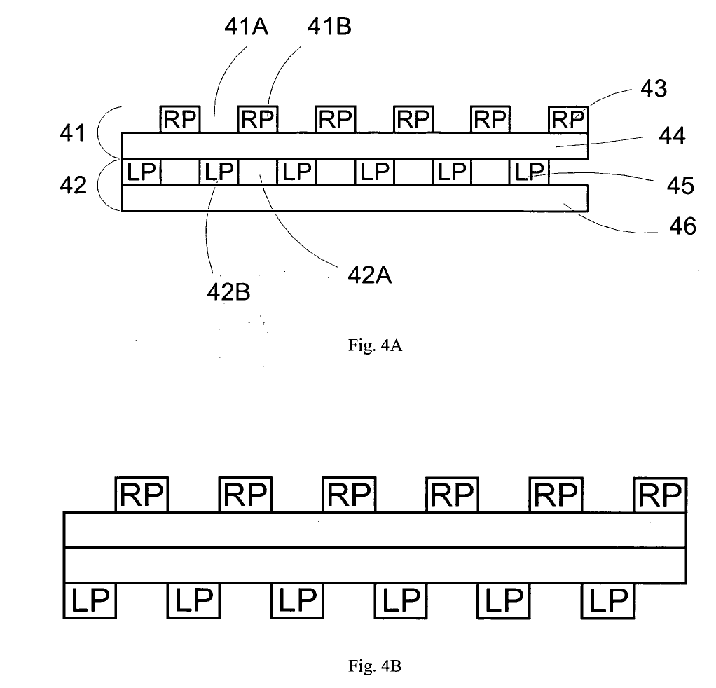

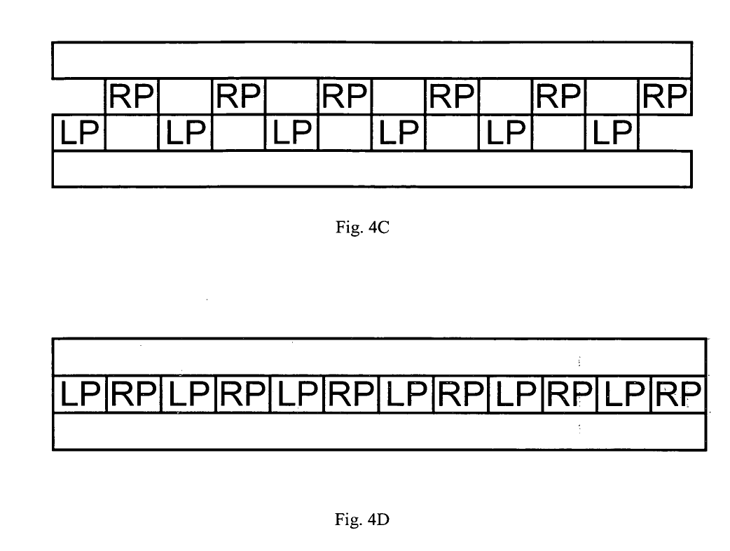

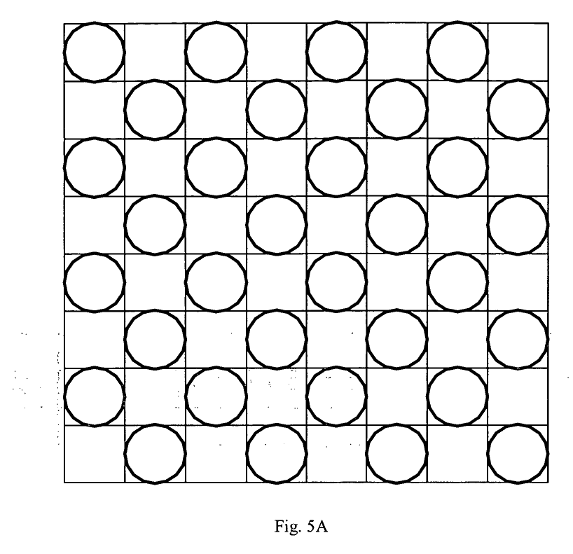

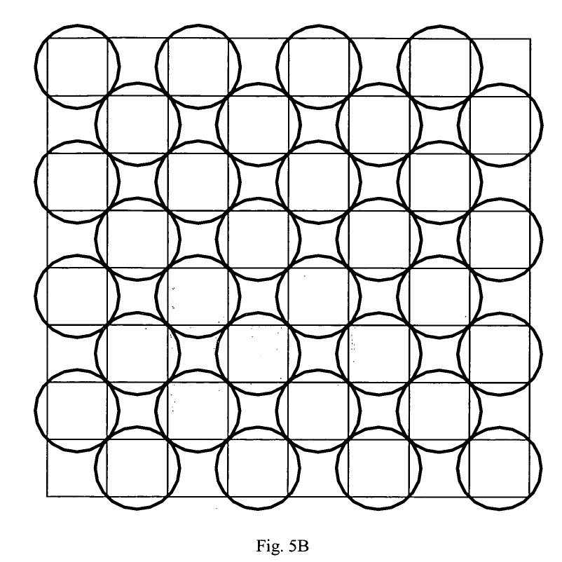

FIG. 4 show various embodiments of the stereopolarizers where the individual polarizers comprise a drilled out polarizer laminated on non-polarizing transparent sheet. The polarizer sheet is preferably thin, in order of millimeters or less, and more preferably sub-millimeter for ease of laser drilling, thus lamination is desirable to improve strength. FIG. 4A shows a stereopolarizer comprising two polarizers 41 and 42. Polarizer 41/42 comprises a polarizer sheet 43/45 laminated on a non-polarizing transparent sheet 44/46, with sections 41A/42B drilled out by laser, leaving only the polarizing section 41B/42A, respectively. The two polarizers 41 and 42 are laminated together with the polarizing sections of one polarizer corresponded to the drilled out sections of other polarizer. The lamination of polarizers 41 and 42 are such that the transparent sheets 44 and 46 are alternate, sandwiching the polarizer sheets 43 and 45. Alternatively, the lamination of polarizers 41 and 42 can be so that the transparent sheets are facing each other as in FIG. 4B, or that the polarizer sheets are facing each other as in FIG. 4C. As an alternative, in an embodiment where the drilled out section is larger than the polarizer sections, the polarizer sheets can be interlaced as shown in FIG. 4D.

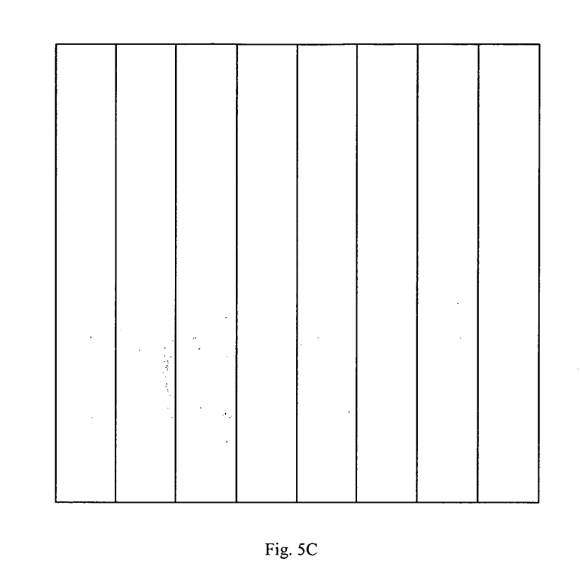

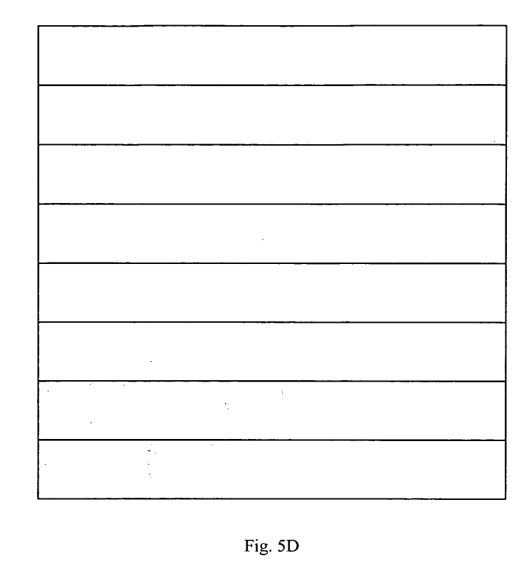

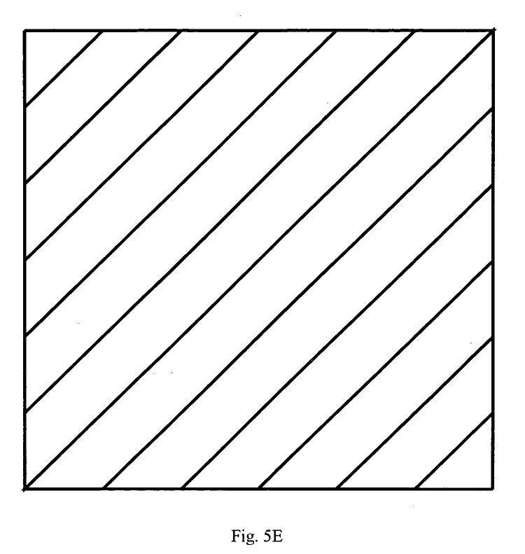

FIG. 5 show various embodiments for the drilled out polarizer. FIG. 5A shows a polarizer with circular (or ellipse) drilled out section. The drilled out sections are smaller than the polarizer sections, and thus in this embodiment, the transparent sheet might not be necessary. Alternatively, FIG. 5B shows similar embodiment with the drilled out section larger than the polarizer sections, and thus the polarizer would need a backing sheet to hold in place. FIGS. 5C, 5D and 5E show polarizers with line drilled out sections, vertically, horizontally, or at an angle, respectively.

The polarized sheet generally comprise laminating on a transparent film; and then directing a laser source onto the polarized sheet film of the laminate to drill a plurality of sections such as holes or lines through the thickness of the polarized sheet film. The transparent film, which can also serve as a backing layer, can be laminated onto the polarized sheet film using any known method. The adhesion can be permanent, or can be temporary so that the polarized sheet can be peeled off from the laminate. The transparent film material used may be any material suitable for laminating onto a polarized sheet film, such as polycarbonates, polyimides, polyamides, polysulfone, polyolefin, polyurethane, polyethers, polyether imides, polyethylene and polyesters.

Laser energy of sufficient energy is applied to the polarized sheet film of the laminate for a sufficient amount of time or number of pulses such that holes are formed which extend preferably completely through the polarized sheet film.

The laser source is normally determined to some extent by the polarized sheet material. Generally, the laser source must supply a sufficient amount of energy of a wavelength which can remove effectively a plurality of sections in the polarized sheet material. The fabrication process comprises a laser beam (continuous or pulsed) directing at the polarized sheet, and melted material from the focus region of the laser beam is expelled from the polarized sheet. The laser beam can drill out completely, or the laser beam can stop at a predetermined depth. Further, the fabrication process can comprise more than one laser beams, with power from one laser beam not enough for drilling. In this case, at the intersection of the laser beams, the power is combined and enough for drilling.

Laser beams, such as CO₂ lasers, excimer lasers, YAG lasers, have been used extensively for a variety of materials machining purposes including drilling or cutting. Processing using excimer lasers is preferred since excimer lasers can have higher precision and less heat damage compared to CO₂ and Nd:YAG lasers. In CO₂ and Nd:YAG lasers, the material is typically heated to melt or vaporize, thus material changes from solid state to liquid or gaseous state. Excimer lasers generate laser light in ultraviolet to near-ultraviolet spectra, from 0.193 to 0.351 microns, and thus the photons have high energy, resulting in reduced interaction time between laser radiation and the material being processed. Excimer lasers thus can remove material through direct solid-vapor ablation. The incident photon energy can be high enough to break the chemical bonds of the target material directly into its chemical components, with no liquid phase transition.

In laser drill, the quality and the shape of the laser beam can determine the quality, quantity and efficiency of drilling process. In many lasers, the output energy distribution over the beam profile is nonhomogeneous and if not reshaped to produce a uniform distribution would result in uneven drilling. Also a beam spot having a traditional Gaussian irradiance profile can be employed, as well as a clipped-Gaussian imaging irradiance profile with the tails of the Gaussian beam reduced, or an imaged shaped Gaussian beam with substantially uniform irradiance profile. Employing a clipped or imaged shaped Gaussian beam facilitates more precise corner rounding and singulation.

The shape of the laser spot can be essentially the same as the hole to be drilled, or to obtain precise holes, the laser spot can be much smaller than the diameter of the hole and the laser beam then tracing around the outline of the hole. Holes of arbitrary shape can be drilled in this manner with x-y control of the beam path. Further, laser drill holes can be tapered, or angled.

The laser beam can be stopped before the beam penetrates through the material leaving a membrane at the bottom of the hole. This can be easily accomplished by counting the number of pulses needed to break through the substrate and ceasing lasing just prior to that point. The preferred parameters for laser drilling may include spot area or lines with dimension of about 1 μm to greater than 800 μm, preferably from about 50 μm to 400 μm, and most preferably from about 100-300 μm.

There are other processes where more than one laser would be an advantage. For example, the laser system can comprise a first laser beam for rapidly removing the bulk of material in an area to form a ragged hole and a second laser beam for accurately cleaning up the ragged hole so that the final hole has dimensions of high precision. The second laser beam typically has a lower power than the first laser beam.

Ultrafast lasers generate intense laser pulses with durations from roughly 10 picoseconds to 10 femtoseconds. Short pulse lasers generate intense laser pulses with durations from roughly 100 picoseconds to 10 picoseconds. Hole sizes as small as a few microns, even sub-microns, can readily be drilled as well as high aspect ratio holes. The use of a short pulse (picosecond) laser source in the present invention solves the problem of minimizing excess thermal effects that lead to misshapen and distorted hole shapes. Thermal effects can also cause other undesirable effects, like thermal damage to substrates.

The method can be carried out using a variety of different lasers, focusing mechanisms, masks or other materials and techniques known to those skilled in the art. Further, the method can be carried out by individually drilling holes within the material or simultaneously drilling groups of holes at the same time. The simultaneous drilling of groups of holes can be carried out using masks and/or beam-splitting or focusing techniques.

The present invention can be applied to horizontal perspective, though various aspects can be generally applied to other perspective.

Perspective drawing, together with relative size, is most often used to achieve the illusion of three dimension depth and spatial relationships on a flat (two dimension) surface, such as paper or canvas. Of special interest is the most common type of perspective, called central perspective, which is displayed, viewed and captured in a plane perpendicular to the line of vision. Viewing the images at angle different from 90° would result in image distortion, meaning a square would be seen as a rectangle when the viewing surface is not perpendicular to the line of vision.

There is a little known class of images that we called it “horizontal perspective” where the image appears distorted when viewing head on, but displaying a three dimensional illusion when viewing from the correct viewing position. In horizontal perspective, the angle between the viewing surface and the line of vision is preferably 45° but can be almost any angle, and the viewing surface is preferably horizontal (wherein the name “horizontal perspective”), but it can be any surface, as long as the line of vision forming a not-perpendicular angle to it.

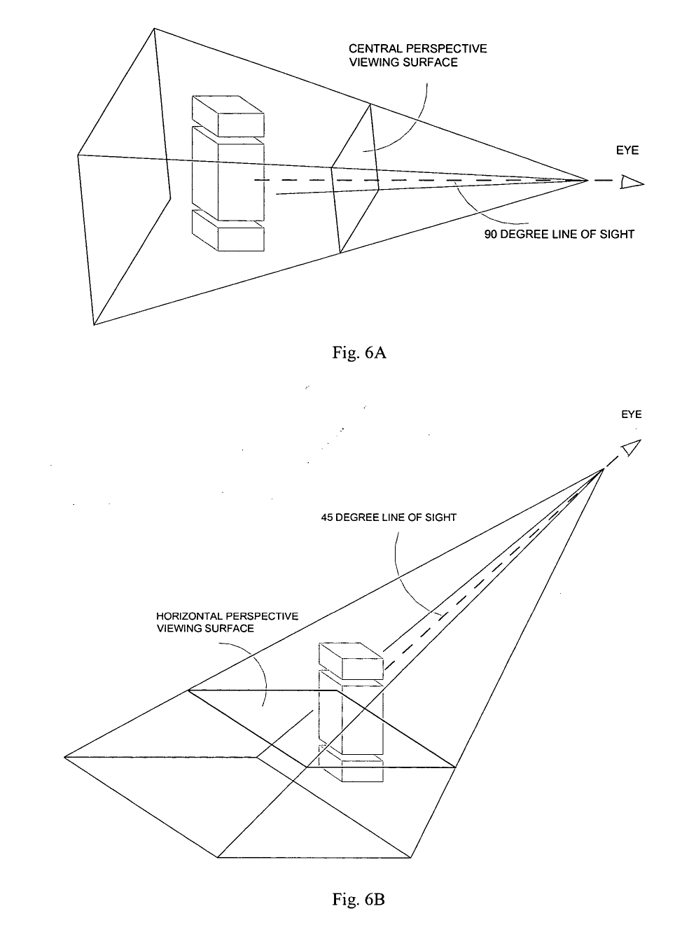

FIG. 6 compares key characteristics that differentiate central perspective and horizontal perspective. Image A shows key pertinent characteristics of central perspective, and Image B shows key pertinent characteristics of horizontal perspective.

In other words, in Image A, the real-life three dimension object (three blocks stacked slightly above each other) was drawn by the artist closing one eye, and viewing along a line of sight perpendicular to the vertical drawing plane. The resulting image, when viewed vertically, straight on, and through one eye, looks the same as the original image.

In Image B, the real-life three dimension object was drawn by the artist closing one eye, and viewing along a line of sight 45° to the horizontal drawing plane. The resulting image, when viewed horizontally, at 45° and through one eye, looks the same as the original image.

One major difference between central perspective showing in Image A and horizontal perspective showing in Image B is the location of the display plane with respect to the projected three dimensional image. In horizontal perspective of Image B, the display plane can be adjusted up and down, and therefore the projected image can be displayed in the open air above the display plane, i.e. a physical hand can touch (or more likely pass through) the illusion, or it can be displayed under the display plane, i.e. one cannot touch the illusion because the display plane physically blocks the hand. This is the nature of horizontal perspective, and as long as the camera eyepoint and the viewer eyepoint is at the same place, the illusion is present. In contrast, in central perspective of Image A, the three dimensional illusion is likely to be only inside the display plane, meaning one cannot touch it. To bring the three dimensional illusion outside of the display plane to allow viewer to touch it, the central perspective would need elaborate display scheme such as surround image projection and large volume.

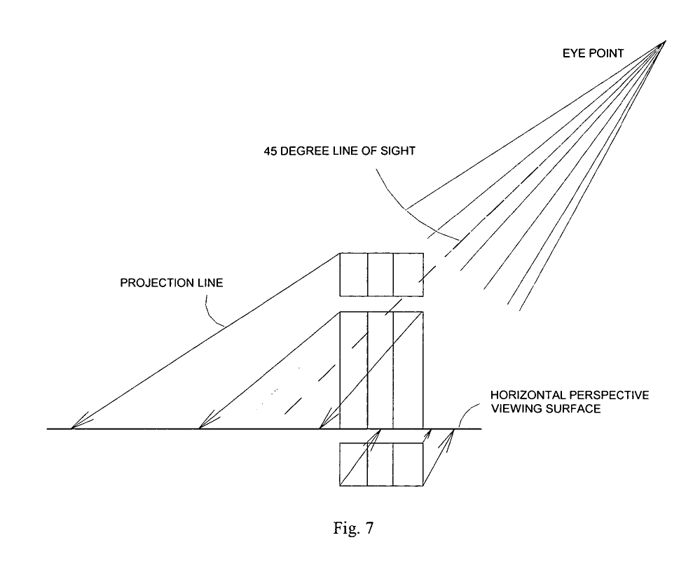

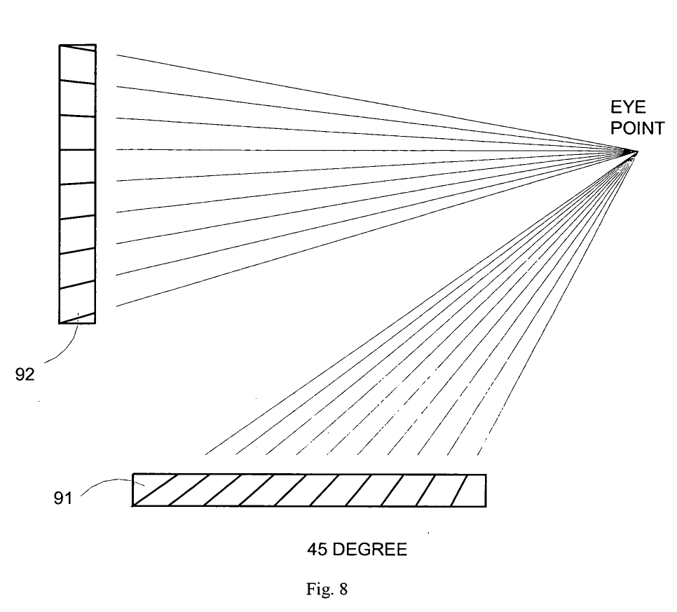

FIG. 7 is an architectural-style illustration that demonstrates a method for making simple geometric drawings on paper or canvas utilizing horizontal perspective. It illustrates the actual mechanics of horizontal perspective. Each point that makes up the object is drawn by projecting the point onto the horizontal drawing plane. To illustrate this, FIG. 7 shows a few of the coordinates of the blocks being drawn on the horizontal drawing plane through projection lines. These projection lines start at the eye point (exageration in FIG. 8 due to scale), intersect a point on the object, then continue in a straight line to where they intersect the horizontal drawing plane, which is where they are physically drawn as a single dot on the paper When an architect repeats this process for each and every point on the blocks, as seen from the drawing surface to the eye point along the line-of-sight the horizontal perspective drawing is complete, and looks like FIG. 7.

Typically, horizontal perspective expects a line of sight of 45° angle to the surface. Normally, this means that the user is standing or seated vertically, and the viewing surface is horizontal to the ground. Although the user can experience horizontal perspective at viewing angles other than 45° (e.g. 55°, 30° etc.), it is the optimal angle for the brain to recognize the maximum amount of spatial information in an open space image. Therefore, for simplicity's sake, 45° angle is used throughout this document to mean “an approximate 45 degree angle”. Further, while horizontal viewing surface is preferred since it simulates viewers' experience with the horizontal ground, any viewing surface could offer similar three dimensional illusion experience. The horizontal perspective illusion can appear to be hanging from a ceiling by projecting the horizontal perspective images onto a ceiling surface, or appear to be floating from a wall by projecting the horizontal perspective images onto a vertical wall surface.

Mathematically, horizontal perspective projection encompasses a viewing pyramid, whose vertex is the location of the camera when generating the 3D images, or the user's eye when viewing the images.

Horizontal perspective is preferably applied to a single user, since the viewpoint needs to be coinciding with the camera point to ensure minimum distortion. Thus unlike other displays where light diffusion is desirable to accommodate many users, focus light is desirable for horizontal perspective display. Thus the polarizer as applied to horizontal perspective would have the holes drilled out in the direction of roughly 45° angle to form a pyramid with the user viewpoint at the vortex. FIG. 8 shows the horizontal polarizer 91 with the laser drilled holes to be 45° angle toward the user eyes. FIG. 8 also shows the vertical polarizer 92 with the laser drilled holes to be a small angle toward the same user eyes. This configuration is applied to multi-plane display with the horizontal polarizer 91 for horizontal perspective image and the vertical polarizer 92 for other perspective, or for 2D display.

The present invention stereopolarizer is well suited for LCD display for stereoscopic 3D display. LCD normally already comprises a polarizer for improving quality. For display system with one LCD screen, this polarizer can be part of the stereopolarizer, meaning only one polarizer with mutually extinguished polarization is needed. For display system with more than one LCD screens, this polarizer cannot be a part of the stereopolarizer, since it would interfere with the operation of the other LCD displays. Thus the stereopolarizer would require two other polarizers with polarization arrangement to allow the LCD polarizer from passing through. For example, for linear polarizer, if the LCDs have 0° polarizer, the stereopolarizer would have −45° and +45° polarizer. The purpose is to provide mutual extinguish polarization for the stereopolarizer (thus the +/−45° polarization), and in the mean time allowing the viewing of the polarizer from the LCD.

What is claimed is:

1. A method to fabricate a stereopolarizer screen for a stereoscopic display, the stereopolarizer screen comprising microscopic sections of mutually extinguishing polarizing filters, the method comprising
providing a first polarizing sheet;
laser drilling a plurality of microscopic sections dispersed throughout the first polarizing sheet.

2. A method as in claim 1 wherein the plurality of microscopic sections forms a checkerboard pattern or a line pattern.

3. A method as in claim 1 wherein the laser beam drills out completely the polarizing sheet, or stops at a predetermined depth.

4. A method as in claim 1 wherein the laser drilling process comprises two laser beams, a first laser beam to form ragged holes and a second laser beam to clean up the ragged holes.

5. A method as in claim 1 wherein the laser drilling process comprises two laser beams,
wherein each laser beam does not have enough power to drill the polarizing sheet,
wherein the combination of two laser beams provides enough power to drill the polarizing sheet, and
wherein the polarizing sheet is drilled at the intersection of the two laser beams.

6. A method as in claim 1 wherein the size of the laser beam drilling holes is between 1 to 1000 microns.

7. A method as in claim 1 further comprising
laser drilling a second polarizing sheet,
laminating the first polarizing sheet and the second polarizing sheet, wherein the laminating process is adapted to provide a mutually extinguishing polarizing multilayer.

8. A method as in claim 1 further comprising
laminating a non-polarizing sheet onto the first polarizing sheet.

9. A method as in claim 1 further comprising
laminating a non-polarizing sheet onto the second polarizing sheet.

10. A method to fabricate a stereopolarizer screen for a stereoscopic display, the stereopolarizer screen comprising microscopic sections of mutually extinguishing polarizing filters, the method comprising
providing a polarizing sheet;
laser drilling a plurality of microscopic sections dispersed throughout the polarizing sheet,
wherein the drilling angle is between 20 to 70 degrees with respect to the plane of the stereopolarizer screen.

11. A method as in claim 10 wherein the plurality of microscopic sections forms a checkerboard pattern or a line pattern.

12. A method as in claim 10 wherein the laser beam drills out completely the polarizing sheet, or stops at a predetermined depth.

13. A method as in claim 10 wherein the laser drilling process comprises two laser beams, a first laser beam to form ragged holes and a second laser beam to clean up the ragged holes.

14. A method as in claim 10 wherein the laser drilling process comprises two laser beams,
wherein each laser beam does not have enough power to drill the polarizing sheet,
wherein the combination of two laser beams provides enough power to drill the polarizing sheet, and
wherein the polarizing sheet is drilled at the intersection of the two laser beams.

15. A method as in claim 10 wherein the size of the laser beam drilling holes is between 1 to 1000 microns.

16. A method as in claim 10 further comprising
laser drilling a second polarizing sheet,
laminating the first polarizing sheet and the second polarizing sheet, wherein the laminating process is adapted to provide a mutually extinguishing polarizing multilayer.

17. A method as in claim 10 further comprising
laminating a non-polarizing sheet onto the first polarizing sheet.

18. A method as in claim 10 wherein the drilled polarizing sheet is adapted to provide stereoscopic screen for a horizontal perspective stereoscopic display.

19. A method as in claim 10 wherein the angles of the microscopic sections of the polarizing filters are parallel to each other.

20. A method as in claim 10 wherein the angles of the microscopic sections of the polarizing filters are focused to a point.
